(19) United States
(12) Patent Application Publication
(10) Pub. No.: US 2012/0053732 A1
(43) Pub. Date: Mar. 1, 2012

(54) REAL TIME SYSTEM AND METHOD FOR INTEGRATED HOME SAFETY MANAGEMENT

(75) Inventor: Jeong Hyun PARK, Daejeon (KR)

(73) Assignee: Electronics and Telecommunications Research Institute, Daejeon (KR)

(21) Appl. No.: 13/069,990

(22) Filed: Mar. 23, 2011

(30) Foreign Application Priority Data
Aug. 25, 2010 (KR) 10-2010-0082627

(51) Int. Cl. G06F 19/00; G06F 15/00; G06F 15/16; G08B 21/00; G06F 21/00

(52) U.S. Cl. 700/275; 340/540; 726/5; 709/204; 702/183

(57) ABSTRACT

Disclosed is a real time system for integrated home safety management. The real time system for integrated home safety management includes: a plurality of sensors collecting information in the home and confirming energy usage used in the home; an integrated reading unit confirming the energy usage at a predetermined date to generate a first home status information corresponding to the energy usage; a safe management unit confirming, using the information in the home, whether abnormality symptom occurs and generating a second home status information corresponding to the abnormality symptom when the abnormality symptom occurs; and a gateway transmitting at least one of the first and second home status information to an affiliated system.

### CROSS-REFERENCE TO RELATED APPLICATIONS

This application claims priority under 35 U.S.C. §119 to Korean Patent Application No. 10-2010-0082627, filed on Aug. 25, 2010, in the Korean Intellectual Property Office, the disclosure of which is incorporated herein by reference in its entirety.

### TECHNICAL FIELD

The following description relates to a home automation system, and more particularly, to a real time system and method for integrated home safety management capable of supporting to rapidly cope with abnormality-symptoms using information sensed from sensors.

### BACKGROUND

Generally, a meter for measuring energy usage such as electricity, water supply, gas, heat, etc., is installed at each home and metermen of each energy supplier periodically visit each home to read a meter to collect fees for energy usage. According to the prior art, meters for measuring the energy usage should be used separately, thereby spoil the beauty and causes inconvenience to separately record and manage the reading report.

Further, according to the related art, since the abnormality-symptoms, such as gas leakage, fire breakout, etc., is sensed through the five senses of a person in the home, they cannot be sensed when there are no people in the home. Moreover, according to the prior art, it is difficult to rapidly cope with the abnormality-symptoms even when the abnormality-symptoms are sensed, which leads to a great probability to cause lethal accidents.

In addition, the prior art does not have a countermeasure against a case where a thief is invaded into a vacant house. Of cause, a service is used that manages the door and dispatches the guard when the door unjustly opens, but it is a loose countermeasure not catching a thief if the thief runs away before the guard is arrived.

Meanwhile, married working couples are being increased in recent and a vacant house is being increased accordingly. Therefore, there is a need to manage a mail delivery service or a home delivery service, including safety management.

### SUMMARY

In one general aspect, a real time system for integrated home safety management includes: a plurality of sensors collecting information in a home and confirming energy usage used in the home; an integrated reading unit confirming the energy usage at a predetermined date to generate a first home status information corresponding to the energy usage; a safe management unit confirming, using the information in the home, whether abnormality symptom occurs and generating a second home status information corresponding to the abnormality symptom when the abnormality symptom occurs; and a gateway transmitting at least one of the first and second home status information to an affiliated system.

In another general aspect, a real time method for integrated home safety management, includes: reading energy usage used in a home at a predetermined date; confirming whether abnormality symptom occurs in the home using information sensed by at least one sensor; dividing the read energy usage into information to be transmitted to energy suppliers and converting the divided information into home status information to transmit the home status information to the energy suppliers; and transmitting the home status information corresponding to the abnormality symptom to an affiliated system corresponding to the abnormality symptom when the abnormality symptom occurs.

In another general aspect, a real time method for integrated home safety management, includes: monitoring whether a mail arrives when mail service is set by a user; reporting an arrival of the mail to a personal terminal when the mail arrives; opening a mailbox to receive the mail and closing the mailbox according to control of the personal terminal; and transferring confirmation signature for receipt of the mail from the personal terminal to a terminal of a delivery person having delivered the mail.

Other features and aspects will be apparent from the following detailed description, the drawings, and the claims.

### BRIEF DESCRIPTION OF THE DRAWINGS

FIG. 1 is a configuration diagram showing an exemplary real time system and for integrated home safety management;

FIG. 2 is a configuration diagram showing an exemplary monitoring system;

FIG. 3 is a table showing an exemplary home status information code system;

FIG. 4 is a flow chart showing an exemplary method of home safety management;

FIG. 5 is a flow chart showing an exemplary method of home mail management; and

FIG. 6 is a flow chart showing an exemplary integrated home reading method.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

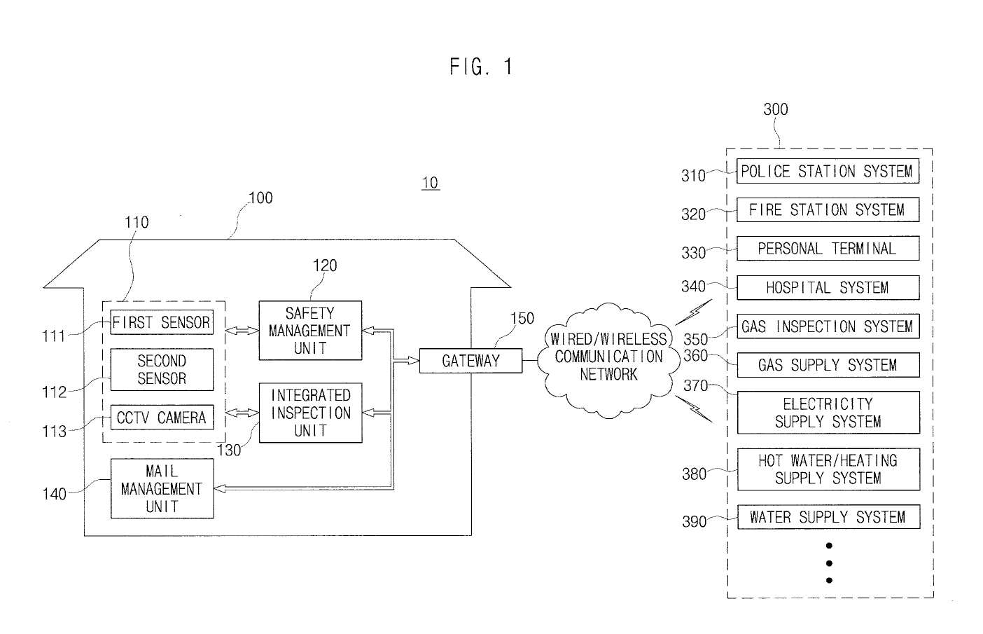

Hereinafter, exemplary embodiments of the present invention will be described in detail with reference to the accompanying drawings. FIG. 1 is a configuration diagram showing an exemplary real time system and for integrated home safety management.

As shown in FIG. 1, a real time system 10 for integrated home safety management includes a plurality of sensors 110, a safety management unit 120, an integrated reading unit 130, a mail management unit 140, and a gateway 150.

The plurality of sensors 110 include a first sensor 111 sensing gas leakage, fire, robbery, entrance and exit, short circuit, water leakage, temperature, humidity, or the like, a second sensor 112 sensing energy usage of water supply, electricity, gas, heating, hot water, or the like, used in the home, and thermal infrared closed-circuit television (CCTV) cameras 113 installed at the interior, the window, or the door, or the like, to photograph the monitoring area. In this configuration, the plurality of sensors 110 may transfer sensed information to a safety management unit 120 through sink nodes.

The safety management unit 120 confirms sensed information of gas leakage, fire, robbery, entrance and exit, short circuit, water leakage, temperature, humidity, or the like, to confirm abnormality-symptoms in the home and transmits home status information to an affiliated system 300 when the abnormality-symptoms occur, such that thereby making it possible to support to rapidly cope with the abnormality-symptoms. In this case, the safety management unit 120 may compare the sensed information with the predetermined reference to determine that the abnormality-symptoms occur in the home when the sensed information is out of the predetermined reference.

Further, the safety management unit 120 may operate an emergency bell, warning lamp, etc., when the abnormality-symptoms occur to enable people around the home to cope with the abnormality-symptoms or people to guide to be evacuated to a safe place.

The integrated reading unit 130 converts the energy usage into the home status information to be transmitted to each energy supplier and transmits it to the affiliated system 300. In detail, the integrated reading unit 130 converts the water usage into the home status information to be transmitted to a water supply system 390, electricity usage into the home status information to be transmitted to an electricity supply system 370, converts hot water/heating usage to be transmitted to a hot water/heating supply system 380, and then, transmits each home status information to each energy supply system 360 to 390.

The mail management unit 140 includes sensors, RFID readers, a touch screen, or the like and manages the arrival of mails delivered to the home, the receipt of mails, the opening and closing of a mailbox, etc.

For example, the mail management unit 140 senses a uniform of a mailman photographed by a camera sensor, sound pronounced as “delivery”, “mail” by a sound sensor, RFID tags attached to the mail by the RFID reader, touch screen menu selection by a delivery person, etc., thereby making it possible to confirm the arrival of mails.

The gateway 150 is connected to a sensor node configured of the plurality of sensors 110, the integrated reading unit 130, the safety management unit 120, the mail management unit 140, and the wired/wireless communication network to intervene the communication among the sensor node, the integrated reading unit 130, the safety management unit 120, and the mail management unit 140 and the affiliated system 300. In this configuration, the wired/wireless communication network may be a wired/wireless Internet network, a CDMA network, etc.

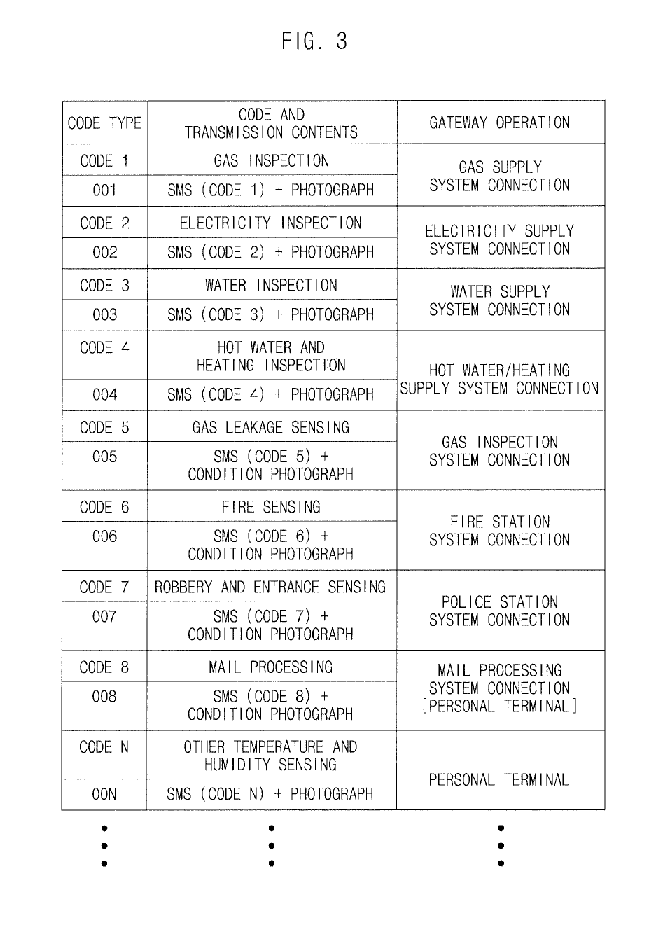

In other words, the gateway 150 confirms code systems of the home status information to transmit the home status information to the affiliated system 300 corresponding to the code systems and transmit the received information from the affiliated system 300 to the integrated reading unit 130, the safety management unit 120, the mail management unit 140, etc. This will be described below with reference to FIG. 3.

FIG. 1 shows, for example, a case where the gateway 150, the integrated reading unit 130, the safety management unit 120, and the mail management unit 140 are configured separately; however, the gateway 150, the integrated reading unit 130, the safety management unit 120, and the mail management unit 140 may be configured to partially or entirely be integrated.

The affiliated system 300 includes a police station system 310, a fire station system 320, a personal terminal 330, a hospital system 340, a gas supply system 360, an electricity supply system 370, a hot water/heating supply system 380, and a water supply system 390.

For example, the police station system 310, the fire station system 320, the personal terminal 330, or the hospital system 340 may confirm the abnormality-symptoms from the home status information and take a rapid action accordingly.

The gas supply system 360, the electricity supply system 370, the hot water/heating supply system 380, or the water supply system 390 confirms each energy usage from the home status information to determine an energy use fee for each home.

In addition, the personal terminal 330 confirms the arrival of mails from the home status information and transmits the opening codes to open the mailbox in order to receive the mails and then, transfers his/her confirmation signature.

Meanwhile, the real time system 10 for integrated home safety management according to the present invention may communicate with the monitoring system 200 that statistically processes information including the home status information transmitted and received between the gateway 150 and the affiliated system 300 and databases it.

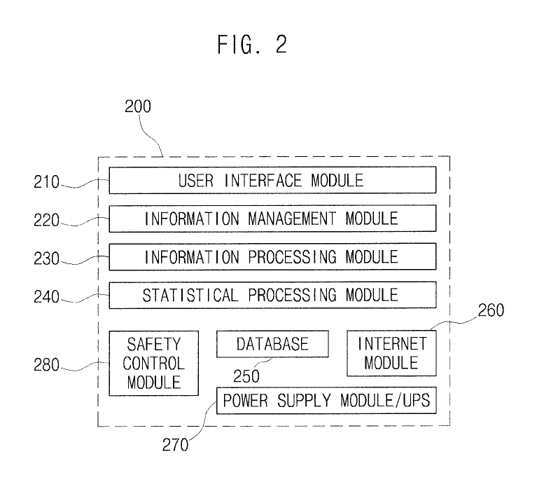

As shown in FIG. 2, the monitoring system 200 supports to remotely manage and monitor the real time system 10 for integrated home safety management and includes a user interface module 210, an information management module 220, an information processing module 230, a statistical processing module 24, a database 250, an Internet module 260, a safety control module 280, a power supply module 270, or the like. Each component will be described below.

In detail, the user interface module 210 provides a user interface, the information management module 220 stores and transmits the home status information and build database using the home status information, the information processing module 230 processes the home status information according to the input of the user, and the statistical processing module 240 performs the statistical processing for the home status information according to the input of the user. The safety control module 280 intervenes transferring the home status information from the safety management unit 120 to the affiliated system 300 and the database 250 stores the databased home status information.

Hereinafter, the code systems of the home status information will be described with reference to FIG. 3. FIG. 3 is a table showing an exemplary home status information code system. FIG. 3 shows, for example, a case where the home status information is configured of codes, photographs, moving pictures, etc.

As shown in FIG. 3, code 1 (001) is a code marking the gas reading and the home status information written by the code 1 (001) is transmitted to the gas supply system 360.

Code 2 (002) is a code marking the electricity reading and the home status information written by code 2 (002) is transmitted to the electricity supply system 370.

Code 3 (003) is a code marking the water reading and the home status information written by code 3 (003) is transmitted to the water supply system 390.

Code 4 (004) is a code marking the hot water/heating reading and the home status information written by code 4 (004) is transmitted to the hot water/heating supply system 380.

Code 5 (005) is a code marking the gas leakage sensing and the home status information written by the code 5 (005) is transmitted to the gas supply system 360 or a gas inspection system 350.

Code 6 (006) is a code marking the fire sensing and the home status information written by code 6 (006) is transmitted to the fire station system 320.

Code 7 (007) is a code marking the robbery/invasion sensing and the home status information marked by the code 7 (007) is transmitted to the police station system 310.

Code 8 (008) is a code marking the mail processing and the home status information marked by the code 8 (008) is transmitted to the personal terminal 330 of the user.

Code N (00N) is a code marking the temperature/humidity sensing and the home status information marked by the code N (00N) is also transmitted to the personal terminal 330 of the user.

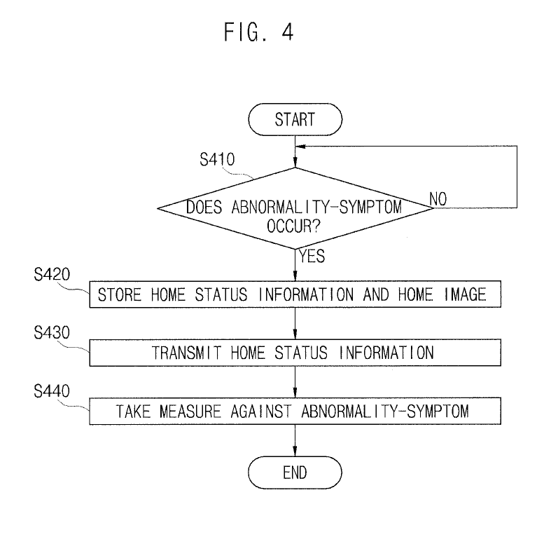

An exemplary method of home safety management will be described with reference to FIG. 4. FIG. 4 is a flow chart showing an exemplary method of home safety management.

Referring to FIG. 4, the safety management unit 120 uses the information sensed by the plurality of sensors 110 to confirm whether the abnormality-symptoms occur (S410).

The safety management unit 120 generates the home status information on the abnormality-symptoms if it is determined that the abnormality-symptoms occur and stores the generated home status information and home images photographed at the same time (S420).

The safety management unit 120 transmits the home status information and the home images to the affiliated system 300 via the gateway 150 and the wired/wireless communication network (S430). In this configuration, the safety management unit 120 transmits the home status information to the affiliated system 300 corresponding to the abnormality-symptoms in order to take a rapid measure.

For example, the safety management unit 120 transmits the home status information to the fire station system 320 when the fire is sensed and transmits the home status information to the police station system 310 when the robbery or invasion is sensed.

In addition, the safety management unit 120 may warn the risk to people in the home or around the home through the warning lamp and the emergency bell.

The affiliated system 300 confirms the occurrence of the abnormality-symptoms from the home images and the home status information and rapidly takes the measure accordingly (S440).

Thereafter, when the abnormality-symptoms are solved, the affiliated system 300 informs the real time system 10 for integrated home safety management that the abnormality-symptoms are solved.

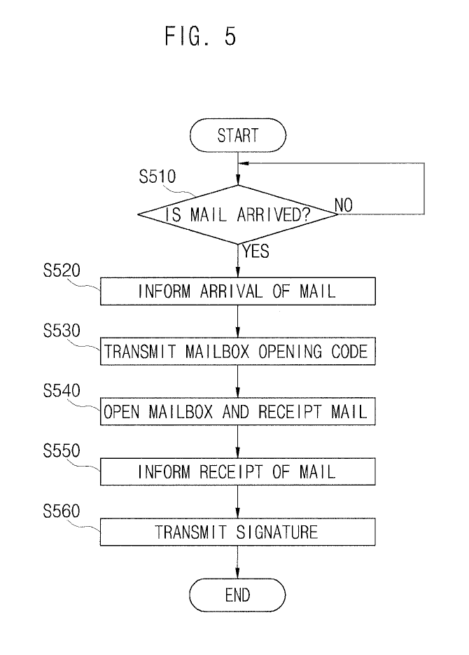

An exemplary method of home mail management will be described below with reference to FIG. 5. FIG. 5 is a flow chart showing an exemplary method of home mail management.

Referring to FIG. 5, the mail management unit 140 monitors whether the mail is arrived if the user is out and the mail service is set (S510).

The mail management unit 140 informs the personal terminal of the user of the arrival of mails when mails are arrived (S520). In this case, the mail management unit 140 may inform the arrival of mails by short messages, image messages, video chatting, etc.

The user recognizes the arrival of mails through the personal terminal, confirms the mails and the delivery person and then, transmits a mailbox opening code as expressing his/her intention of receiving the mails (S530).

When the mail management unit 140 receives the mailbox opening code, it opens the mailbox, receives the mails and then, closes the mailbox (S540).

The mail management unit 140 informs the personal terminal of the user of the receipt of mails and induces the user's signature (S550).

When the user confirms the receipt of mails and transmits his/her signature to the terminal of the delivery terminal, the mail management unit 140 records the mail processing information (S560). In this case, the signature may be directly transferred from the personal terminal to the delivery terminal and may be transferred to the delivery terminal via the mail management unit 140.

Thereafter, the mail management unit 140 transfers the mails stored in the mail box to the user when the user comes back home and requests the mails.

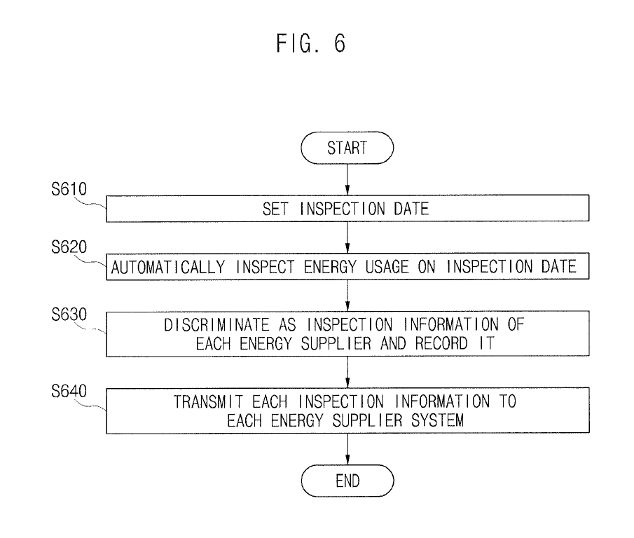

An exemplary method for integrated home reading will be described below with reference to FIG. 6. FIG. 6 is a flow chart showing an exemplary method for integrated home reading.

Referring to FIG. 6, the integrated reading unit 130 automatically reads the energy usage such as water, electricity, gas, hot water, heating, etc., that are being used on the set reading date (S620) when the user sets the reading date (610). In this case, the integrated reading unit 130 takes a measure to discriminate the energy usage before the reading and the energy usage after the reading such as the reset of the energy usage counted by the sensor 110, etc.

Then, the integrated reading unit 130 discriminates the read energy usage as the home status information (that is, reading information) to be transmitted to each energy supply system 360 to 390 and records the discriminated home status information (S630).

The integrated reading unit 130 transfers the recorded reading information to each energy supply system 360 to 390 (S640).

Thereafter, each energy supply system 360 to 390 uses the read information to determine the energy use fee for each home and the integrated reading unit 130 is in the standby state without separately confirming the energy usage until the next reading date.

As set forth above, the present invention can automatically read and integrally manage the energy usage and improve the spatial usage or the interior performance without the separate meter.

Further, the present invention uses the information sensed by the sensors to continuously monitor the abnormality-symptoms of accidents and supports to take the rapid measure even when the abnormality-symptoms are found.

In addition, the present invention can inform the arrival of mails to the user while he/she is out, open the mailbox under the user's approval to receive the mails, and provide the user's signature to the terminal of a delivery person.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A real time system for integrated home safety management, comprising:
a plurality of sensors collecting information in a home and confirming energy usage used in the home;
an integrated reading unit confirming the energy usage at a predetermined date to generate a first home status information corresponding to the energy usage;
a safe management unit confirming, using the information in the home, whether abnormality symptom occurs and generating a second home status information corresponding to the abnormality symptom when the abnormality symptom occurs; and
a gateway transmitting at least one of the first and second home status information to an affiliated system.

2. The system of claim 1, wherein the plurality of sensors collects the information in the home of at least one of gas leakage, fire, robbery, entrance and exit, electricity leakage, water leakage, temperature, and humidity.

3. The system of claim 1, wherein the integrated reading unit confirms the energy usage used in the home of at least one energy supply system of water, electricity, gas, heating or hot water at the predetermined date respectively, and transmits the energy usage to the at least one energy supply system.

4. The system of claim 1, wherein the safe management unit warns people in or around the home of danger through an emergency bell or a warning lamp, when the abnormality symptom occurs.

5. The system of claim 1, further comprising a mail management unit reporting arrival of a mail to a personal terminal and opening or closing a mailbox according to control of the personal terminal to receive the mail.

6. The system of claim 5, wherein the mail management unit reports receipt of the mail to the personal terminal when receipt of the mail is completed to transfer user signature to a terminal of a delivery person having delivered the mail.

7. The system of claim 5, wherein the mail management unit includes at least one of a touch screen operating and displaying a mail management menu, a RFID reader sensing a RFID tag attached to the mail, a camera photographing the surroundings of a front door, and a sound sensor sensing sound of the surroundings.

8. The system of claim 7, wherein the mail management unit confirms arrival of the mail through at least one of an operation of the mail management menu, sensing of the RFID tag, an image of the delivery person, and voice of the delivery person.

9. The system of claim 1, wherein the gateway confirms the affiliated system to which the first and second home status information is to be transmitted using a code included in the first and second home status information.

10. The system of claim 1, wherein the affiliated system includes at least one of a police station system, a fire station system, a personal terminal, a hospital system, a gas check system, a gas supply system, an electricity supply system, a hot water/heating supply system, and a water supply system.

11. The system of claim 1, wherein the real time system communicates with a monitoring system compiling information including the home status information transmitted and received between the gateway and the affiliated system to make the information into database.

12. A real time method for integrated home safety management, comprising:
reading energy usage used in a home at a predetermined date; confirming whether abnormality symptom occurs in the home using information sensed by at least one sensor;
dividing the read energy usage into information to be transmitted to energy suppliers and converting the divided information into home status information to transmit the home status information to the energy suppliers; and
transmitting the home status information corresponding to the abnormality symptom to affiliated system corresponding to the abnormality symptom when the abnormality symptom occurs.

13. The method of claim 12, further comprising setting the predetermined date according to reading schedule of the energy suppliers.

14. The method of claim 12, wherein the confirming includes:
comparing the sensed information with a predetermined reference; and
determining that the abnormality symptom occurs in the home when the sensed information is out of the predetermined reference.

15. The method of claim 12, wherein the transmitting includes warning people in or around the home of danger through an emergency bell or warning lamp.

16. The method of claim 12, further comprising:
monitoring whether a mail arrives when mail service is set by a user;
reporting an arrival of the mail to a personal terminal when the mail arrives at the home;
opening a mailbox to receive the mail and closing the mailbox according to control of the personal terminal; and
receiving confirmation signature for receipt of the mail from the personal terminal to transfer the confirmation signature to a terminal of a delivery person.

17. The method of claim 16, wherein the monitoring includes monitoring whether a mail management menu on a touch screen is operated, whether a RFID reader senses a RFID tag attached to the mail, an image outside a front door, and sound outside of the front door.

18. A real time method for integrated home safety management, comprising
monitoring whether a mail arrives when mail service is set by a user;
reporting an arrival of the mail to a personal terminal when the mail arrives;
opening a mailbox to receive the mail and closing the mailbox according to control of the personal terminal; and
transferring confirmation signature for receipt of the mail from the personal terminal to a terminal of a delivery person having delivered the mail.

19. The method of claim 18, wherein the transferring includes at least one of:
directly transferring the confirmation signature to the terminal of the delivery person by the person terminal; and
receiving the confirmation signature from the personal terminal to transfer the confirmation signature to the terminal of the delivery person.

20. The method of claim 18, wherein the monitoring includes monitoring whether a mail management menu on a touch screen is operated, whether a RFID reader senses a RFID tag attached to the mail, an image outside a front door, and sound outside of the front door.
